(19) United States
(12) Patent Application Publication
(10) Pub. No.: US 2026/0061392 A1
(43) Pub. Date: Mar. 5, 2026

(54) MODIFIED ALUMINOSILICATE INORGANIC MESOPOROUS MATERIAL AND PREPARATION METHOD THEREFOR

(71) Applicants: Suzhou University of Science and Technology, Suzhou (CN); China Water Resources and Environment Research Institute (Suzhou) Co., Ltd, Kunshan (CN)

(72) Inventors: Cuimei Li, Suzhou (CN); Mingjie Liang, Suzhou (CN); Shaoguang Zhang, Kunshan (CN)

(21) Appl. No.: 19/281,196

(22) Filed: Jul. 25, 2025

(30) Foreign Application Priority Data
Aug. 30, 2024 (CN) 202411207838.8

(51) Int. Cl. B01J 20/16; B01J 20/24; B01J 20/28; B01J 20/30; B01J 20/32; C02F 1/28; C02F 101/10; C02F 101/16

(52) U.S. Cl. CPC B01J 20/16; B01J 20/24; B01J 20/28059; B01J 20/3021; B01J 20/3078; B01J 20/3204; B01J 20/3236; B01J 20/3268; C02F 1/288; C02F 1/281; C02F 2101/105; C02F 2101/16

(57) ABSTRACT

The disclosure relates to a modified aluminosilicate inorganic mesoporous material and a preparation method therefor. Through calcination modification of nitrate and modification of alkaline chitosan, and through the regulation of parameters such as a particle size and a specific surface area of the aluminosilicate, a concentration of a nitrate solution, a solid-to-liquid ratio of aluminosilicate particles to the nitrate solution, a calcination time, a calcination temperature, and a pH value, a mass fraction and a temperature of the chitosan solution, the modified aluminosilicate inorganic mesoporous material with a stable specific surface area ranging from 30 m²/g to 40 m²/g can be stably prepared. Moreover, the size of a pore channel inside the mesoporous material can be as small as sub-nanometer scale.

### CROSS-REFERENCE TO RELATED APPLICATION

This application claims priority of Chinese Patent Application No. 202411207838.8, filed on Aug. 30, 2024, the entire contents of which are incorporated herein by reference.

### TECHNICAL FIELD

The disclosure relates to the technical field of sewage treatment, and specifically relates to a modified aluminosilicate inorganic mesoporous material and a preparation method therefor.

### BACKGROUND

Developing efficient and economical nitrogen and phosphorus removal technologies is of great significance for protecting water resources and maintaining ecological balance. Among the numerous nitrogen and phosphorus removal methods, adsorption method has attracted great attention due to its simple operation and low cost. As a cheap and readily available natural mineral, aluminosilicate has a porous structure, endowing it with good adsorption performance, and is therefore widely applied in the treatment of water bodies contaminated with ammonia nitrogen and phosphorus.

However, natural aluminosilicate still has many limitations in practical applications: 1) high impurity content: natural aluminosilicate often contains a relatively high content of impurities, which not only reduce the adsorption efficiency of the natural aluminosilicate but may cause secondary pollution to water bodies; 2) narrower pore channel: the pore channel size of the natural aluminosilicate is relatively narrow, which limits the adsorption capacity of the natural aluminosilicate for macromolecular pollutants, and has limited adsorption effect in particular on well-dissolved ammonia nitrogen and phosphorus ions; 3) smaller specific surface area: a smaller specific surface area means a limited number of adsorption sites, making it difficult to meet the demands of large-scale water body treatment; and 4) complex modification method: currently, most of the modification methods for aluminosilicate have the problems of a single treatment function or a complex process, and it is difficult to achieve efficient adsorption and simplified processes at the same time.

Mesoporous materials, featuring high specific surface area, large pore volume, and unique and adjustable mesoporous structure, have broad application prospect in various fields. Particularity, in the field of nanomedicine, mesoporous materials can load guest molecules into pore channels and achieve responsive release and delivery through the opening and closing of the pore, and this characteristic provides a new idea for drug delivery, gene therapy, etc. However, in the field of water treatment, the application of mesoporous materials still faces some challenges, such as how to effectively combine the advantages of the mesoporous structure with the low cost and easy availability of the aluminosilicate to develop economical and efficient nitrogen and phosphorus removal materials.

Given the above background, there is an urgent need for a new modification solution for aluminosilicate, which aims at solving the following problems: 1) improving adsorption performance: enhancing the adsorption capacity of aluminosilicate for ammonia nitrogen and phosphorus through modification, especially the adsorption efficiency in low-concentration polluted water bodies; 2) simplifying the modification process: seeking a simple and easy-to-operate modification method to reduce production cost and facilitate large-scale promotion and application; 3) maintaining material stability: ensuring that the modified aluminosilicate can maintain stable adsorption performance in complex water body environments and avoid secondary pollution; and 4) broadening the application scope: making the modified aluminosilicate to be suitable not only for the removal of single pollutants but also for the simultaneous treatment of multiple pollutants, thereby improving the comprehensive effect of water body treatment.

### SUMMARY

To solve the above-described technical problems, the present application provides a modified aluminosilicate inorganic mesoporous material and a preparation method therefor.

To realize the above-mentioned objective, the present application employs the following technical solutions:

the present application provides a preparation method for a modified aluminosilicate inorganic mesoporous material, including the following steps:
S1, after crushing an aluminosilicate, screening aluminosilicate particles of 80 meshes to 100 meshes;
S2, soaking the aluminosilicate particles obtained in step S1 in a nitrate solution at a concentration of 1 mol/L to 6 mol/L for 12 h to 24 h, with each 1 g of the aluminosilicate particles corresponding to a volume of 10 mL to 60 mL of the nitrate solution, after filtration, performing drying at 95° C. to 110° C., and then performing calcination at 400° C. to 500° C. for 1 h to 2 h, to obtain primary modified aluminosilicate particles; and
S3, soaking the primary modified aluminosilicate particles obtained in step S2 in a chitosan solution with a temperature of 40° C. to 60° C. and a mass concentration of 3% to 5% for 0.5 h to 3 h, and after filtration and washing, performing drying at 95° C. to 110° C., to obtain a modified aluminosilicate inorganic mesoporous material.

In a further improvement of the present application, a specific surface area of the aluminosilicate is 14 m²/g to 16 m²/g.

In a further improvement of the present application, the aluminosilicate is at least one of sodium aluminosilicate, potassium aluminosilicate and calcium aluminosilicate.

In a further improvement of the present application, in step S2, the nitrate is either sodium nitrate or potassium nitrate.

In a further improvement of the present application, in step S2, a concentration of the nitrate solution is 4 mol/L, each 1 g of the aluminosilicate particles corresponds to a volume of 40 mL of the nitrate solution, and a soaking time is 12 h.

In a further improvement of the present application, in step S2, a temperature for the calcination is 400° C., and a time for the calcination is 1 h.

In a further improvement of the present application, in step S3, the chitosan solution is an alkaline chitosan solution with a pH value of 9.5 to 10.5.

In a further improvement of the present application, in step S3, a mass concentration of the chitosan solution is 5%, a temperature of the chitosan solution is 50° C., and a time for soaking in the chitosan solution is 1 h.

To realize the above-mentioned objective, the present application provides a modified aluminosilicate inorganic mesoporous material prepared according to the above-described preparation method.

In a further improvement of the present application, a specific surface area of the modified aluminosilicate inorganic mesoporous material is 30 m²/g to 40 m²/g.

The beneficial effects of the present application lie in that the present application provides a preparation method for a modified aluminosilicate inorganic mesoporous material. Through calcination modification of the nitrate and modification treatment of the alkaline chitosan, and through the regulation of parameters such as the particle size and specific surface area of aluminosilicate, the concentration of the nitrate solution, the solid-to-liquid ratio of aluminosilicate particles to the nitrate solution, calcination time, calcination temperature, and the pH value, mass fraction and temperature of the chitosan solution, a modified aluminosilicate inorganic mesoporous material with a stable specific surface area ranging from 30 m²/g to 40 m²/g can be stably prepared. Moreover, the size of the pore channel inside the mesoporous material can be as small as sub-nanometer scale.

In addition, by directly calcining the aluminosilicate after soaking in the nitrate solution without washing with water, secondary pollution from the washing wastewater of nitrate can be effectively avoided.

### BRIEF DESCRIPTION OF DRAWINGS

FIG. 1 is a scanning electron microscopy image showing an internal pore channel structure of a modified aluminosilicate inorganic mesoporous material in Embodiment 1; and

FIG. 2 is a transmission electron microscopy image showing the internal pore channel structure of the modified aluminosilicate inorganic mesoporous material in Embodiment 1.

### DETAILED DESCRIPTION

The technical solutions of the present application will be described clearly and completely by reference to the embodiments of the present application below. Obviously, the embodiments described are only some, rather than all embodiments of the present application. On the basis of the embodiments of the present application, all other embodiments obtained by those ordinary skilled in the art without creative efforts fall within the scope of protection of the present application.

For clearer objective, technical solutions and advantages, the present application will be further described in detail below with reference to the specific embodiments.

### Embodiment 1

After crushing the natural sodium aluminosilicate, sodium aluminosilicate particles of 80 meshes to 100 meshes were screened. The specific surface area of the sodium aluminosilicate particles of 80 meshes to 100 meshes was 15.63 m²/g. The sodium aluminosilicate particles of 80 meshes to 100 meshes were soaked in a sodium nitrate solution at a concentration of 4 mol/L for 24 h, with each 1 g of the sodium aluminosilicate particles corresponding to a volume of 40 mL of the sodium nitrate solution. After taking out the sodium aluminosilicate particles, solid-liquid separation was carried out through vacuum filtration, followed by drying at 105° C. The dried sodium aluminosilicate particles were placed in a muffle furnace, with the muffle furnace being heated at a rate of 10 K/min to 400° C. After maintaining a constant temperature of 400° C. for 1 h, the sodium aluminosilicate particles were taken out and cooled to room temperature in a desiccator, and sodium nitrate-calcined modified sodium aluminosilicate was obtained.

The sodium nitrate-calcined modified sodium aluminosilicate particles were soaked in a chitosan solution with a mass concentration of 5% and a temperature of 50° C. for 1 h, with the pH value of the chitosan solution being maintained from 9.5 to 10.5. Solid-liquid separation was performed through vacuum filtration, followed by washing with water and drying at 100° C., so that a modified aluminosilicate inorganic mesoporous material was obtained. After testing, a specific surface area of the modified aluminosilicate inorganic mesoporous material was 35 m²/g.

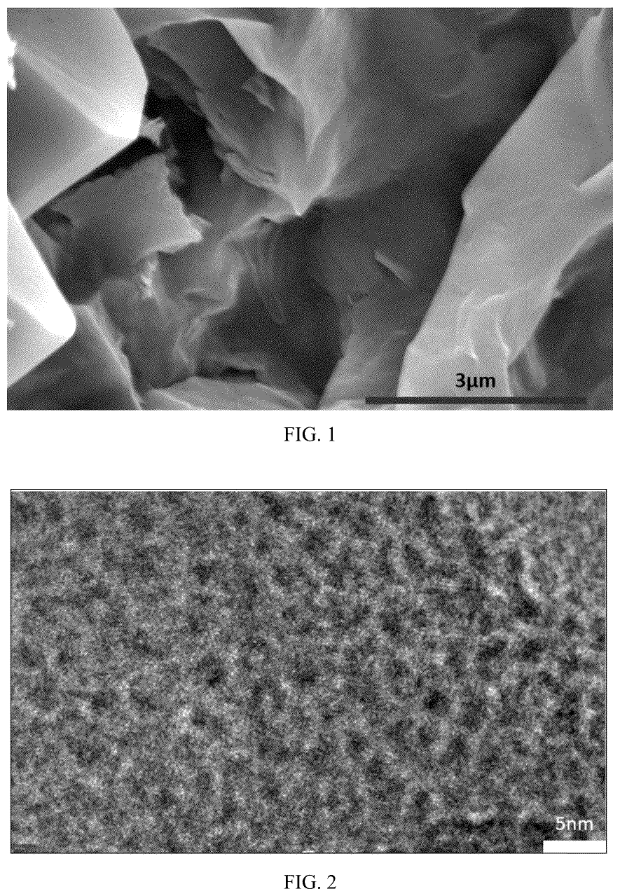

A scanning electron microscopy and a transmission electron microscopy were used to test the prepared modified aluminosilicate inorganic mesoporous material. The scanning electron microscopy image of the internal pore channel structure of the modified aluminosilicate inorganic mesoporous material is shown in FIG. 1. As can be seen from FIG. 1, there are pore channels of 3 μm within the modified aluminosilicate inorganic mesoporous. The transmission electron microscopy image of the internal pore channel structure of the modified aluminosilicate inorganic mesoporous material is shown in FIG. 2. As can be seen from FIG. 2, there are pore channels of 5 nm within the modified aluminosilicate inorganic mesoporous material. As can be seen from FIG. 1 and FIG. 2, the size of the internal pore channels of the modified aluminosilicate inorganic mesoporous material obtained in the embodiment is in mesoporous scale, even reaching the sub-nanometer scale.

### Embodiment 2

The difference of the embodiment over Embodiment 1 lies in that a concentration of sodium nitrate selected is 1 mol/L.

### Embodiment 3

The difference of the embodiment over Embodiment 1 lies in that a concentration of sodium nitrate selected is 2 mol/L.

### Embodiment 4

The difference of the embodiment over Embodiment 1 lies in that a concentration of sodium nitrate selected is 6 mol/L.

### Embodiment 5

The difference of the embodiment over Embodiment 1 lies in that each 1 g of the sodium aluminosilicate particles corresponds to a volume of 10 mL of a nitrate solution.

### Embodiment 6

The difference of the embodiment over Embodiment 1 lies in that each 1 g of the sodium aluminosilicate particles corresponds to a volume of 20 mL of a nitrate solution.

### Embodiment 7

The difference of the embodiment over Embodiment 1 lies in that each 1 g of the sodium aluminosilicate particles corresponds to a volume of 60 mL of a nitrate solution.

### Embodiment 8

The difference of the embodiment over Embodiment 1 lies in that a muffle furnace is heated up to 500° C. at a rate of 10 K/min, the temperature is held at 500° C. for 1 h, and then a sample is taken out.

### Embodiment 9

The difference of the embodiment over Embodiment 1 lies in that sodium aluminosilicate particles of 80 meshes to 100 meshes are soaked in a potassium nitrate solution at a concentration of 4 mol/L for 24 h, with each 1 g of the sodium aluminosilicate particles corresponding to a volume of 40 mL of the potassium nitrate solution.

### Embodiment 10

The difference of the embodiment over Embodiment 1 lies in that the natural potassium aluminosilicate is used to replace natural sodium aluminosilicate.

### Embodiment 11

The difference of the embodiment over Embodiment 1 lies in that the natural calcium aluminosilicate is used to replace natural sodium aluminosilicate.

### Embodiment 12

The difference of the embodiment over Embodiment 1 lies in that the natural calcium aluminosilicate, natural potassium aluminosilicate and natural sodium aluminosilicate are used to replace natural sodium aluminosilicate.

### Comparative Embodiment 1

The difference of the comparative embodiment over Embodiment 1 lies in that a concentration of sodium nitrate selected is 0.5 mol/L.

### Comparative Embodiment 2

The difference of the comparative embodiment over Embodiment 1 lies in that a concentration of sodium nitrate selected is 10 mol/L.

### Comparative Embodiment 3

The difference of the comparative embodiment over Embodiment 1 lies in that each 1 g of the sodium aluminosilicate particles corresponds to a volume of 5 mL of a nitrate solution.

### Comparative Embodiment 4

The difference of the comparative embodiment over Embodiment 1 lies in that each 1 g of the sodium aluminosilicate particles corresponds to a volume of 100 mL of a nitrate solution.

### Comparative Embodiment 5

The difference of the comparative example over Embodiment 1 lies in that a muffle furnace is heated up to 300° C. at a rate of 10 K/min, the temperature is held at 300° C. for 1 h, and then a sample is taken out.

### Comparative Embodiment 6

The difference of the comparative example over Embodiment 1 lies in that a muffle furnace is heated up to 600° C. at a rate of 10 K/min, the temperature is held at 600° C. for 1 h, and then a sample is taken out.

The modified aluminosilicate inorganic mesoporous material prepared in Embodiment 1 was used for treating sewage of different initial concentrations, and the results are shown in Table 1.

TABLE 1
ammonia nitrogen and total phosphorus concentrations before and after treatment
of sewage of different initial concentrations, as well as removal rates

| | Ammonia | Total | | Ammonia | | Total | |
|---|---|---|---|---|---|---|---|
| | nitrogen | phosphorus | | nitrogen | Ammonium | phosphorus | Total |
| | concentration | concentration | | concentration | nitrogen | concentration | phosphorus |
| | before | before | Material | after | removal | after | removal |
| Serial | reaction | reaction | dosage | reaction | rate | reaction | rate |
| number | (mg/L) | (mg/L) | (g/L) | (mg/L) | (%) | (mg/L) | (%) |
| 1 | 25 | 0.87 | 35 | 1.4 | 94.4 | 0.04 | 95.4 |
| 2 | 50 | 1.35 | 60 | 2.0 | 96 | 0.12 | 91.1 |
| 3 | 100 | 1.63 | 80 | 5.0 | 95 | 0.14 | 91.4 |
| 4 | 150 | 1.9 | 100 | 9.6 | 93.6 | 0.17 | 91.1 |
| 5 | 2 | 0.7 | 35 | 0.12 | 94 | 0.06 | 91.4 |

As can be seen from Table 1, in the technical solution provided in the present application, an ammonia nitrogen removal rate for sewage with an ammonia nitrogen concentration of 2 mg/L to 150 mg/L reaches 90% or more, and a total phosphorus removal rate for sewage with a total phosphorus concentration of 0.5 mg/L to 2 mg/L reaches 90% or more.

The modified aluminosilicate inorganic mesoporous materials prepared in Embodiments 1 to 4 and Comparative Embodiments 1 to 2 were respectively used for nitrogen and phosphorus removal treatment on sewage of the same concentration. Before treatment, in the sewage, the initial ammonia nitrogen concentration was 10 mg/L, and the initial total phosphorus concentration was 1.5 mg/L. All the dosages of the modified aluminosilicate inorganic mesoporous materials were at 35 g/L, and the reaction time was 1 day. The results are shown in Table 2.

TABLE 2
ammonia nitrogen and total phosphorus concentrations before and after treatment
for different sodium nitrate concentrations as well as removal rates

| | | Ammonium | | Total | |
|---|---|---|---|---|---|
| | Sodium | nitrogen | Ammonium | phosphorus | Total |
| | nitrate | concentration | nitrogen | concentration | phosphorus |
| | concentration | after reaction | removal | after reaction | removal |
| | (mol/L) | (mg/L) | rate (%) | (mg/L) | rate (%) |
| Comparative | 0.5 | 1.31 | 86.9 | 0.19 | 87.3 |
| Embodiment | | | | | |
| 1 | | | | | |
| Embodiment | 1 | 1.22 | 87.8 | 0.18 | 88.0 |
| 2 | | | | | |
| Embodiment | 2 | 0.89 | 91.1 | 0.12 | 92.0 |
| 3 | | | | | |
| Embodiment | 4 | 0.82 | 91.8 | 0.09 | 94.0 |
| 1 | | | | | |
| Embodiment | 6 | 0.79 | 92.1 | 0.08 | 94.7 |
| 4 | | | | | |
| Comparative | 10 | 1.09 | 89.1 | 0.21 | 86.0 |
| Embodiment | | | | | |
| 2 | | | | | |

As can be seen from Table 2, in the technical solution provided by the present application, when the concentration of sodium nitrate is relatively low, the ion-exchange capacity decreases, and high-temperature calcination of NO³⁻ can only offer limited improvement to the pore channel structure of aluminosilicate; and when the concentration of sodium nitrate is relatively high, an excessive amount of nitrate enters the aluminosilicate, and the pore channels are prone to collapse after calcination. Preferably, the concentration of the sodium nitrate solution is 1 mol/L to 6 mol/L.

The modified aluminosilicate inorganic mesoporous materials prepared in Embodiment 1, Embodiments 5-7, and Comparative Embodiments 3-4 were respectively used for nitrogen and phosphorus removal treatment on sewage of the same concentration. Before treatment, in the sewage, the initial ammonia nitrogen concentration was 20 mg/L, and the initial total phosphorus concentration was 1.0 mg/L. All the dosages of the modified aluminosilicate inorganic mesoporous materials were at 40 g/L, and the reaction time was 2 days. The results are shown in Table 3.

TABLE 3
ammonia nitrogen and total phosphorus concentrations before
and after treatment for different solid-to-liquid ratios of
aluminosilicate and sodium nitrate, as well as removal rates

| | Solid-liquid | Ammonium | | Total | |
|---|---|---|---|---|---|
| | ratio of | nitrogen | Ammonium | phosphorus | Total |
| | aluminosilicate | concentration | nitrogen | concentration | phosphorus |
| | and sodium | after reaction | removal rate | after reaction | removal rate |
| | nitrate (g:mL) | (mg/L) | (%) | (mg/L) | (%) |
| Comparative | 1:5 | 2.25 | 88.8 | 0.25 | 75.0 |
| Embodiment | | | | | |
| 3 | | | | | |
| Embodiment | 1:10 | 1.62 | 91.9 | 0.13 | 87.0 |
| 5 | | | | | |
| Embodiment | 1:20 | 1.51 | 92.5 | 0.11 | 89.0 |
| 6 | | | | | |
| Embodiment | 1:40 | 1.32 | 93.4 | 0.10 | 90.0 |
| 1 | | | | | |
| Embodiment | 1:60 | 1.28 | 93.6 | 0.08 | 92.0 |
| 7 | | | | | |
| Comparative | 1:100 | 1.29 | 93.6 | 0.09 | 91.0 |
| Embodiment | | | | | |
| 4 | | | | | |

As can be seen from Table 3, in the technical solution provided by the present application, when the volume of the sodium nitrate solution is relatively small, the cation exchange and the attachment of nitrate are limited; and when the volume of the sodium nitrate solution is excessively large, there is little impact on improving the pollutant adsorption rate of the modified aluminosilicate. Preferably, each 1 g of the aluminosilicate particles corresponds to the volume of 10 mL to 60 mL of the nitrate solution.

The modified aluminosilicate inorganic mesoporous materials prepared in Embodiment 1, Embodiment 8, and Comparative Embodiments 5-6 were respectively used for nitrogen and phosphorus removal treatment on sewage of the same concentration. Before treatment, in the sewage, the initial ammonia nitrogen concentration was 20 mg/L, and the initial total phosphorus concentration was 1.0 mg/L. All the dosages of the modified aluminosilicate inorganic mesoporous materials were at 35 g/L, and the reaction time was 2 days. The results are shown in Table 4.

TABLE 4
ammonia nitrogen and total phosphorus concentrations before and after treatment
for different calcination temperatures as well as removal rates

| | | Ammonium | | Total | |
|---|---|---|---|---|---|
| | | nitrogen | Ammonium | phosphorus | Total |
| | | concentration | nitrogen | concentration | phosphorus |
| | Calcination | after reaction | removal | after reaction | removal |
| | temperature | (mg/L) | rate (%) | (mg/L) | rate (%) |
| Comparative | 300 | 3.63 | 81.85 | 0.37 | 63 |
| Embodiment | | | | | |
| 5 | | | | | |
| Embodiment | 400 | 1.62 | 91.9 | 0.11 | 89 |
| 1 | | | | | |
| Embodiment | 500 | 1.45 | 92.75 | 0.09 | 91 |
| 8 | | | | | |
| Comparative | 600 | 1.96 | 90.2 | 0.12 | 88 |
| Embodiment | | | | | |
| 6 | | | | | |

As can be seen from Table 4, in the technical solution provided by the present application, when the calcination temperature is too low (below 400° C.), it fails to exert a significant pore-enlarging effect; and when the calcination temperature is too high (above 500° C.), it is prone to causing the collapse of the aluminosilicate framework. Preferably, the calcination temperature is 400° C. to 500° C.

Although the specification is described in accordance with the implementations, not each implementation contains only one independent technical solution. The description is set forth in such a manner as to be clear only, and a person skilled in the art is to take the specification as a whole, and technical solutions in various implementations can be suitably combined to form other implementations that will be understood by the person skilled in the art.

The series of detailed descriptions listed above merely provide specific explanations of the feasible implementations for the present application, rather than limiting the scope of protection of the present application. Any equivalent implementations or modifications that do not deviate from the technical spirit of the present application are included in the scope of protection of the present application.

1. A preparation method for a modified aluminosilicate inorganic mesoporous material, comprising the following steps:
S1, after crushing an aluminosilicate, screening aluminosilicate particles of 80 meshes to 100 meshes, a specific surface area of the aluminosilicate being 14 m²/g to 16 m²/g;
S2, soaking the aluminosilicate particles obtained in step S1 in a nitrate solution at a concentration of 1 mol/L to 6 mol/L for 12 h to 24 h, with each 1 g of the aluminosilicate particles corresponding to a volume of 10 mL to 60 mL of the nitrate solution, after filtration, performing drying at 95° C. to 110° C., and then performing calcination at 400° C. to 500° C. for 1 h to 2 h, to obtain primary modified aluminosilicate particles; a nitrate being either sodium nitrate or potassium nitrate; and
S3, soaking the primary modified aluminosilicate particles obtained in step S2 in a chitosan solution with a temperature of 40° C. to 60° C. and a mass concentration of 3% to 5% for 0.5 h to 3 h, the chitosan solution being an alkaline chitosan solution with a pH value of 9.5-10.5, and after filtration and washing, performing drying at 95° C. to 110° C., to obtain a modified aluminosilicate inorganic mesoporous material.

2. The preparation method for the modified aluminosilicate inorganic mesoporous material according to claim 1, wherein the aluminosilicate is at least one of sodium aluminosilicate, potassium aluminosilicate and calcium aluminosilicate.

3. The preparation method for the modified aluminosilicate inorganic mesoporous material according to claim 2, wherein in step S2, a concentration of the nitrate solution is 4 mol/L, each 1 g of the aluminosilicate particles corresponds to a volume of 40 mL of the nitrate solution, and a soaking time is 12 h.

4. The preparation method for the modified aluminosilicate inorganic mesoporous material according to claim 1, wherein in step S2, a temperature for the calcination is 400° C., and a time for the calcination is 1 h.

5. The preparation method for the modified aluminosilicate inorganic mesoporous material according to claim 3, wherein in step S2, a temperature for the calcination is 400° C., and a time for the calcination is 1 h.

6. The preparation method for the modified aluminosilicate inorganic mesoporous material according to claim 1, wherein in step S3, a mass concentration of the chitosan solution is 5%, a temperature of the chitosan solution is 50° C., and a time for soaking in the chitosan solution is 1 h.

7. A modified aluminosilicate inorganic mesoporous material prepared by the preparation method according to claim 1.

8. A modified aluminosilicate inorganic mesoporous material prepared by the preparation method according to claim 2.

9. A modified aluminosilicate inorganic mesoporous material prepared by the preparation method according to claim 3.

10. A modified aluminosilicate inorganic mesoporous material prepared by the preparation method according to claim 4.

11. A modified aluminosilicate inorganic mesoporous material prepared by the preparation method according to claim 5.

12. A modified aluminosilicate inorganic mesoporous material prepared by the preparation method according to claim 6.

13. The modified aluminosilicate inorganic mesoporous material according to claim 7, wherein a specific surface area of the modified aluminosilicate inorganic mesoporous material is 30 m²/g to 40 m²/g.

14. The modified aluminosilicate inorganic mesoporous material according to claim 8, wherein a specific surface area of the modified aluminosilicate inorganic mesoporous material is 30 m²/g to 40 m²/g.

15. The modified aluminosilicate inorganic mesoporous material according to claim 9, wherein a specific surface area of the modified aluminosilicate inorganic mesoporous material is 30 m²/g to 40 m²/g.

16. The modified aluminosilicate inorganic mesoporous material according to claim 10, wherein a specific surface area of the modified aluminosilicate inorganic mesoporous material is 30 m²/g to 40 m²/g.

17. The modified aluminosilicate inorganic mesoporous material according to claim 11, wherein a specific surface area of the modified aluminosilicate inorganic mesoporous material is 30 m²/g to 40 m²/g.

18. The modified aluminosilicate inorganic mesoporous material according to claim 12, wherein a specific surface area of the modified aluminosilicate inorganic mesoporous material is 30 m²/g to 40 m²/g.
